(19) United States
(12) Patent Application Publication
(10) Pub. No.: US 2005/0213078 A1
(43) Pub. Date: Sep. 29, 2005

(54) Device for checking security elements

(75) Inventors: Jakob Grob, Mastrils (CH); Andreas Dostmann, Tamins (CH); Klaus Franken, Igis (CH)

Correspondence Address: PILLSBURY WINTHROP SHAW PITTMAN LLP, 1650 TYSONS BOULEVARD, MCLEAN, VA, 22102, US

(73) Assignee: LANDQART, Landqart (CH)

(21) Appl. No.: 10/509,735

(22) PCT Filed: Mar. 25, 2003
(86) PCT No.: PCT/CH03/00191

§ 371 Date: Sep. 30, 2004

(30) Foreign Application Priority Data
Apr. 4, 2002 (CH) 571/02

(51) Int. Cl. G06K 9/74

(52) U.S. Cl. 356/71

(57) ABSTRACT

The invention relates to a device (20) and a method for making visible security elements present in an object (4) and comprising at least one photoluminescent segment which is characterized by linearly polarized photoluminescence and/or linearly polarized absorption. According to the invention, a good contrast is achieved with few interfering signals, by arranging at least one light source (1) and at least one polarization filter (2) in such a way that the light (24) from the light source (1) is linearly polarized (23) by means of the polarization filter (2) and hits the object (4) or the photoluminescent segments in said object, and photoluminescent light (25) from the segments can be observed through another and/or the same polarization filter (2).

### TECHNICAL FIELD

The present invention relates to a device and a method for revealing security elements that are present in an object and that have at least one photoluminescent segment which is characterized by linearly polarized photoluminescence and/or linearly polarized absorption.

A security element of this type has been described, for example in WO 00/19016.

### PRIOR ART

It is generally known that, for security papers and security articles quite generally, for example for banknotes, checks, stocks and shares, bonds, identity papers, passports, drivers' licenses, entry cards, postage stamps and similar documents or, for example, for bank cards, credit cards and the like, use is made of security elements which have the purpose of preventing or making difficult the forgery of these objects by an unauthorized person (R. van Renesse, “Optical Document Security” (1997), Artech House, Boston). Equally, such security elements are used for the purpose of identifying the authenticity or validity of objects or, quite generally, permitting or making easier the identification of objects.

For example, the use of security threads or strips, which, for example, can consist of plastic coated with metal, in security papers is widespread, in particular for the use in banknotes and similar securities. If these security threads or strips are, for example, embedded in the security paper and the latter is subsequently printed, however, these security elements cannot readily be detected if the object is observed in reflection. However, they appear as a dark shadow when the object is transilluminated and is therefore observed in transmission.

In particular in order to ensure the security against forgery of security articles, for example of security papers, in recent times many proposals have been made relating to providing security elements with specific characteristics, so that not only the presence of security elements for itself but, in particular, also the presence of specific characteristics is intended to guarantee the authenticity of the secured object (U.S. Pat. No. 4,897,300; U.S. Pat. No. 5,118,349; U.S. Pat. No. 5,314,739; U.S. Pat. No. 5,388,862; U.S. Pat. No. 5,465,301, DE-A 1,446,851; GB 1,095,286). For instance, DE-A 1,446,851 has disclosed a security thread which has a multicolored microprint; in this case, the printing ink can also be fluorescent. The areas printed in different colors are so small or so close together in this thread that they cannot be distinguished by the naked eye and therefore appear to the observer as a single-colored pattern. On the other hand, the microprint and its different colors can be detected with the aid of a magnifying glass or a microscope.

Furthermore, reference is made to WO 00/19016, in which a security paper or quite generally security articles are described which contain at least one security element that has at least one photoluminescent segment which is distinguished by linearly polarized photoluminescence and/or linearly polarized absorption. In this document, it is pointed out that linearly polarized excitation light, which, for example, can be generated by an external light source in conjunction with a linear polarizer, is absorbed to different extents by the segment, depending on the orientation of the polarization axis of the segment and the polarization direction of the excitation light, which can lead to a high light/dark contrast when observed by the naked eye.

Furthermore, reference is made to U.S. Pat. No. 5,892,239, which describes an instrument for the identification of security features on a security document, in which unpolarized light is used for illumination and polarization is used during the detection. A similar device is described by U.S. Pat. No. 4,990,790.

In connection with such security features having photoluminescent segments with polarizing properties, there is a need for devices for the detection or checking of such security features. Such devices are to have a high resolution and good contrast and, at the same time, should be capable of implementation in a technically simple and in particular a very compact manner, that is to say should be resistant, easy to carry and capable of inexpensive production, in order to permit wide distribution.

### SUMMARY OF THE INVENTION

Accordingly, the invention is based on the object of providing a method and, respectively, a device for revealing security elements present in an object, the security elements to be observed having at least one photoluminescent segment which is characterized by linearly polarized photoluminescence and/or linearly polarized absorption. At the same time, the device is to be very compact and to permit easy and reliable detection of the security elements without having to fall back on a complicated and possibly temperamental design.

This object is achieved in that at least one light source and at least one polarization filter are arranged in such a way that the light from the light source is linearly polarized by the polarization filter, strikes the object and, respectively, the photoluminescent segments present therein, and photoluminescent light from the segment in the visible range can be observed through a further and/or the same polarization filter.

In other words, the nub of the invention is to send both the light shone in and the photoluminescent light from the segment through a polarization filter. As a result, in a surprisingly simple way, the contrast of the observation is increased and interference signals, which normally arise because of scattered light or because of inaccurate polarization, can be suppressed efficiently. This is in particular the case when the security elements exhibit linearly polarized photoluminescence and linearly polarized absorption and when, in addition, both irradiation and observation are carried out through the same polarization filter. This arrangement is particularly simple and efficient, since in this case the contrast can be increased to a particular extent and only one polarization filter is necessary, which is used for both light paths and therefore has a polarizing action in both spectral ranges (excitation and photoluminescence).

According to a first preferred embodiment of the invention, the at least one light source emits light in the UV range, and the photoluminescence from the at least one segment lies in the visible range. Segments of this type are invisible to the naked eye under normal conditions and exhibit particularly high security in relation to forgeries. In particular for such security features, there is a need for specific and simple checking instruments.

The light source is preferably a UV light source with an emission in the UV range from 180 to 500 nanometers, typically in the range from 200 to 400 nanometers. In this case, the original light source does not have to be limited to this frequency range but can also be a broadband light source in front of which an appropriate bandpass filter is arranged, so that only UV light in particular in the aforementioned range strikes the object. In principle, it is possible, given such a selection of a broadband light source, that it acts simultaneously as a polarization filter as well. In this way, the arrangement of 2 filters can be avoided. For instance, the light source can be a mercury vapor lamp, a laser light source or a halogen lamp or an arc discharge lamp.

According to a further preferred embodiment of the present invention, the device is configured in such a way that the observation takes place through a filter which substantially does not permit light in the wavelength range of the light source to pass, while light in the wavelength range of the visible photoluminescent light from the segment can pass substantially unimpeded. If, for example, irradiation is carried out in the UV range and observation in the visible range, then an additional filter should be used for the observation which has substantially no transmission in the UV range, while it is transparent to the visible range. In this way, stray light from the light sources (direct stray light or reflected stray light from housing parts or from the object having the security feature) can be suppressed efficiently and the checking of the security features can be improved or simplified.

Another preferred embodiment is distinguished by the fact that the light shone in and the photoluminescent light from the segment pass through the same polarization filter, and that the polarization filter for observation can be rotated about an axis at right angles to the plane of the polarization filter, in particular with the aid of a motor. The rotation of the polarization filter leads to an intensive light/dark effect of the segments (light when the polarization directions lie in parallel, dark when the polarization directions lie at right angles to each other) during the observation, which permits the security features to stand out particularly sharply in relation to the surroundings. In this case, it is recommended to rotate the polarization filter with a rotation frequency in the range from 0.2 to 5 Hz, in particular preferably with a rotation frequency of 0.5 to 2 Hz. At such rotation frequencies, the light/dark effect can best be detected by the human eye.

In technical terms, the rotation of the polarization filter can be implemented by the polarization filter being enclosed in a mounting ring, the polarization filter being rotated by a drive belt which runs around the mounting ring and is driven by a drive wheel moved by a motor, and in particular the mounting ring preferably being rotatably mounted via at least 3 tangentially engaging guide rollers. In this way, use can be made, for example, of a round polarization filter in which the irradiation takes place to a certain extent obliquely from above through the polarization filter by means of a plurality of light sources, and the observation of the reflected light can be carried out vertically from above through the central region of the polarization filter. This simple observation through the center of the polarization filter is not possible if the polarization filter is mounted such that it can be rotated by a central shaft.

A preferred embodiment is distinguished by the fact that only one of the polarization directions (polarization direction of the light shone in or the polarization direction of the filter between object and observation) is rotated. This is achieved by a first polarization filter being arranged between light source and object and by a second polarization filter being arranged between object and observation, and by it being possible for either the first or the second polarization filter to be rotated about an axis at right angles to the plane of the polarization filter, in particular with the aid of a motor, while the other polarization filter is not rotated. This arrangement leads to a particularly pronounced flip-flop effect.

Another preferred involvement is distinguished by the fact that the change in the polarization direction of the light shone in is not effected by means of mechanical rotation of one (or more) polarization filter(s) but by means of various light sources which throw light with a different polarization direction onto the object. This embodiment can be implemented in that at least 2 light sources are provided, in that there is in this case a polarization filter in front of each of the light sources, the polarization directions of the light beams falling on the object from the various light sources being different and the various light sources being activated successively in an alternating manner.

For example, the rotation of the polarization filter when irradiating the object can be simulated in that in each case different polarization directions from different lamps are shone in alternately, to a certain extent stroboscopically. This can be combined with a rotating polarization filter between object and observation or with a stationary polarization filter between object and observation.

In principle, any desired number of different light sources with respectively differently aligned polarization filters can be arranged and these can be activated successively. Depending on the number of different polarization directions connected one after another, the mechanical rotation can in this way be simulated as accurately as desired.

However, a device of this type can be implemented particularly simply by using a few light sources and with a pronounced flip-flop effect in that 2 light sources (or 2 groups of identical light sources, it being possible for each group also to contain more than one light source) are provided, and in that the polarization directions of the light beams falling on the object from the 2 light sources are displaced by 90 degrees, it being possible for the 2 light sources to be switched on and off in an alternating way, preferably at a frequency in the range from 0.2 to 5 Hz, in particular preferably at a frequency of 0.5 to 2 Hz.

According to a further preferred embodiment of the present invention, a camera, in particular preferably a CCD color camera, is provided for the observation, the image recorded by the camera being depicted on a display, in particular preferably a TFT-LCD color display, if appropriate following suitable image processing such as contrast adaptation, color adaptation, brightness adaptation, enlargement and/or resolution adaptation. The use of electronic detection means permits sensitive detection and, in particular, permits image processing that is optimized in relation to the features to be observed. In this way, security features can be detected still better on an appropriate display.

In addition, the camera can preferably be a multichip camera, in particular a three-chip camera. The resolution and therefore the quality of the checking of the security feature can be increased by such superior camera types.

Alternatively or additionally, it is possible to improve the observation or make it easier by observations being carried out through at least one lens or lens combination, in particular preferably through a magnifying glass.

Another preferred embodiment is characterized in that the light source is a UV lamp, preferably a UV tube having a wavelength in the range from about 200 to about 390 nanometers, in particular preferably having a wavelength in the range from about 350 to about 370 nanometers (in each case the maxima of the emission bands), and in that the polarization filter is a broadband linear polarizer which, particularly preferably, has a polarizing action in a wavelength range from 300 to 770 nanometers. For instance, mercury vapor UV lamps, which may be coated with phosphorus in order to shift the center of the emitted line into the desired region (for example 370 nanometers), prove to be suitable. In order that the polarization filter acts in a linearly polarizing manner both in the excitation range and in the observation range, this filter should either have a broadband characteristic or else should be transparent and polarizing, at least in the observation range and in the range of the UV light shone in. It is important to match the characteristics of the UV tube to the characteristics of the polarization filter (or vice versa), that is to say care must be taken that the polarization filter effects efficient linear polarization both in the observation range (for example in the visible range) and in the UV range of the radiation, and losses in the spectral ranges are kept small.

A further improvement in the device according to the invention can be obtained by the device additionally being equipped to check other further security features. In this case, the further security features can be magnetic, electric, optical, electronic, electro-optical features, for example selected from the group comprising bar codes, magnetic strips, conductivity, luminescence, photoluminescence, up-conversion (anti-Stokes), infrared signatures, electronically readable text (OCR text), including those with infrared text, X-ray fluorescence features, etc.

Further preferred embodiments of the method according to the invention are described in the independent claims.

Furthermore, the present invention relates to a method for revealing security elements that are present in an object and that have at least one photoluminescent segment which is characterized by linearly polarized photoluminescence and/or linearly polarized absorption, which method is characterized in that light from at least one light source is linearly polarized by at least one polarization filter, strikes the object and, respectively, the photoluminescent segments present therein, and photoluminescent light from the segment in the visible range is observed through a further and/or the same polarization filter, use particularly preferably being made of a device as has been described above.

### BRIEF DESCRIPTION OF THE FIGURES

The invention is to be explained in more detail below using exemplary embodiments and in conjunction with the drawings, in which:

FIG. 1 a) shows a perspective view of a hand-held instrument having an electronic display; b) shows a central section at right angles to the main axis of a hand-held instrument according to FIG. 1a); c) shows a side view of a hand-held instrument according to FIG. 1a); d) shows a view from below of the upper housing part according to A-A in FIG. 1c); e) shows a view from a part of the lower housing part according to B-B in FIG. 1c); and

FIG. 2 shows a section according to FIG. 1b) through a hand-held instrument without an electronic display.

### PREFERRED EMBODIMENTS OF THE INVENTION

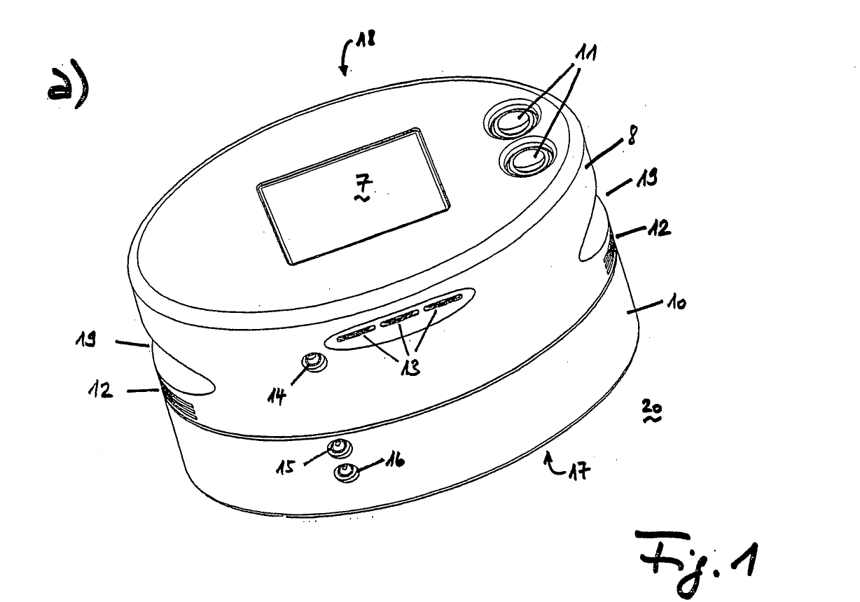

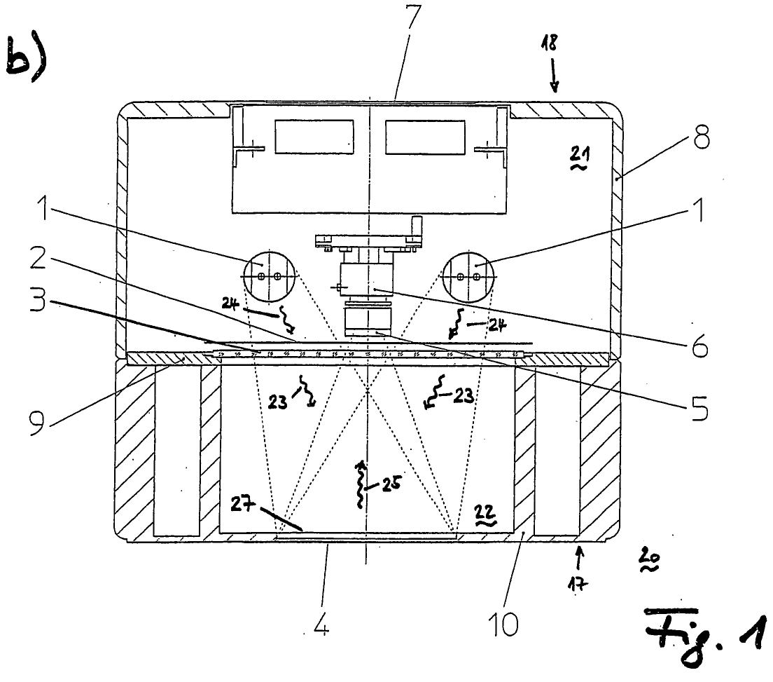

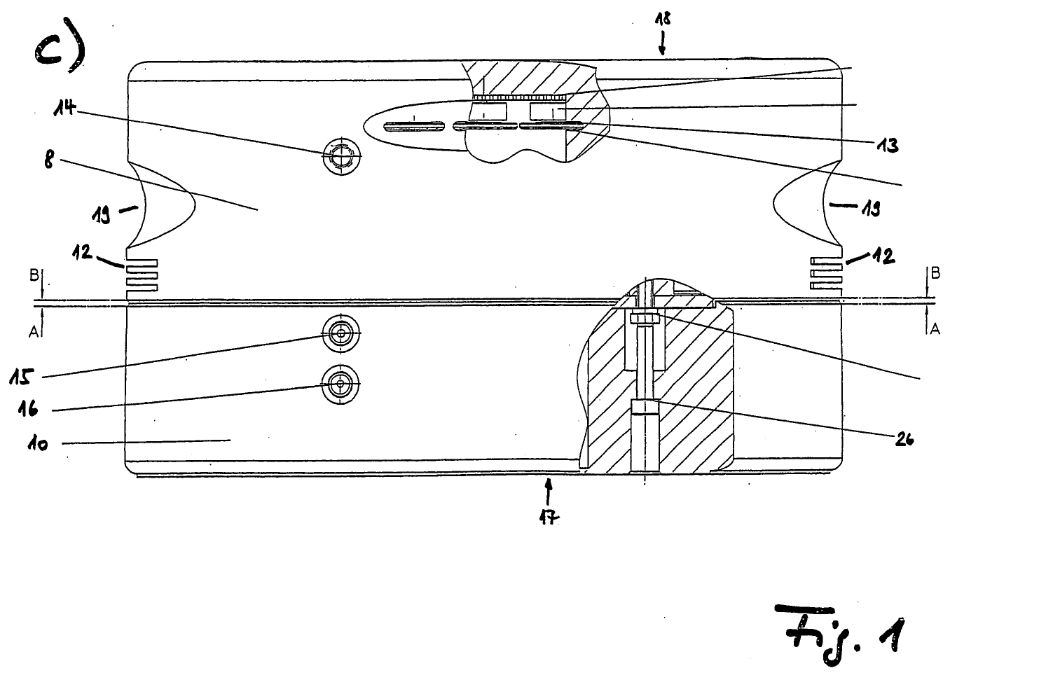

FIG. 1a) shows a perspective view of a hand-held instrument 20 having an electronic display, which is intended to serve as a first exemplary embodiment of the present invention. The hand-held instrument 20 has an upper housing part 8 and a lower housing part 10, which are screwed to each other and which both have an oval cross section. Arranged on the upper side 18 is a TFT-LCD color display 7, on which the object 4 to be examined is depicted. The hand-held instrument 20 has grip notches 19, which make the instrument easier to handle, at the end of the major axis (of the ellipse), at half the height. In addition, ventilation slots 12 are arranged immediately underneath these notches 19, in order to allow the heat produced in the instrument to escape. The instrument has a height of 13.5 cm, and a length along the major axis of 23.3 cm and a width along the minor axis of 15.4 cm. The total weight is less than 10 kg.

On the upper side 18, the instrument has two switches 11, one of the switches being provided to switch on the lamps and the other switch to switch on the motor for the rotation of the polarization filter 2. In addition, the instrument has three rotary controls 13 in the upper region of the long side. These rotary controls 13 permit the brightness, contrast and the color sensitivity of the display 7 to be adjusted in accordance with the requirements. In addition, connecting sockets 14, 15 and 16 are provided, likewise in the region of the long side. One of these connecting sockets is used as a connector 14 for an external display. In other words, via this connecting socket, the output from the CCD camera 6 arranged in the interior can be led to another display. Furthermore, two connections 15 and 16 are provided, one of which is used to connect a battery charger. The power supply of the instrument in autonomous operation is ensured by accumulators which are arranged in the interior of the housing and which can be charged up via this connection 16. The second connector 15 can be used for the connection of an external 12 volt supply if either the accumulators are empty or in principle stationary operation is intended.

FIG. 1b) shows a central section along the minor axis of the ellipsoidal instrument, which is intended to serve the schematic illustration of the function. The instrument has two UV lamps 1 arranged in the upper housing part 8, at the side and parallel to the major axis. These are lamps whose emission characteristics have a maximum in the region of 365 to 370 nm (UVA, for example mercury vapor lamps with appropriate phosphorus coating or UV LEDs). The light 24 leaving these lamps passes through a centrally arranged polarization filter 2, in order then to strike the object 4 having a security feature to be examined as linearly polarized light 23. In this case, it is possible to observe security features which exhibit photoluminescence from the UV range into the visible range, and in which either absorption and/or emission are linearly polarized. These can be an extremely wide range of objects, such as banknotes, certificates, tickets, entry authorizations, postage stamps, identity papers, packages, identity cards, passports, etc, quite generally documents whose security against forgery is intended to be ensured by means of appropriate photoluminescence security features with polarizing properties.

The object 4 is hidden or covered by the instrument for the purpose of observation and is observed through a hole 27 in the underside specifically provided for this purpose. The lower housing part has, above the hole 27, a dark chamber 22 with a height of about 5.5 cm, which is sealed off with respect to the interior 21 in the upper housing part 8 by means of a cover glass 3. Here, the intention of the cover glass 3 is to prevent the possibility of the cavity 21, in which there are optical and electronic devices, being contaminated. The light 25 which is emitted by the object 4 in the visible range and is normally likewise polarized and which can have extremely different colors, depending on the security features, then passes upward through the same polarization filter 2 onto a CCD camera 6. This CCD camera 6 additionally has a filter 5 which eliminates electromagnetic radiation in the frequency range of the light sources 1 from the light entering the camera. In other words, this is a UV filter which does not permit light from the UV lamps 1, stray UV light or UV light reflected from housing parts of the object 4 to get into the CCD camera 6. The CCD camera is connected to a TFT-LCD color display 7, on which the security features of the object 4 are depicted. The data determined by the CCD camera 6 can, if appropriate, be subjected to appropriate image processing, which allows the security features to stand out particularly.

In this instrument, the polarization filter 2 can be rotated for the purpose of observation. This leads to it being possible for a characteristic light/dark effect to be observed during observation. The light/dark effect is produced by the fact that when the polarization of the polarization filter 2 and the polarization direction of the polarizing segment of the security feature are aligned parallel to each other, a bright reflection appears on the display, while no reflection can be observed in the case of orthogonal alignment. Observation through the same polarization filter leads to increased visibility of this light/dark effect, since in this way optimum coordination or adaptation of the polarization direction of irradiation and observation is automatically ensured.

The polarization filter is a broadband polarization filter, that is to say a substrate which efficiently polarizes light in the range from about 300 to about 770 nanometers. Suitable for this are, for example, UV polarizers as can be obtained from 3M or are marketed by Polaroid under the name HNP'B linear ultraviolet*(275-750 nm as transmission and polarization range).

FIG. 1c) shows a side view of the instrument. In this case, it can be seen in particular how the lower housing part 10 is fixed to the upper housing part 8 by fixing screws 26.

FIG. 1d) shows a view according to A-A in FIG. 1c), that is to say a view into the upper housing plant 8 from below. The specific arrangement of the light sources 1 with their mount 29 can be seen, into which the top parts 28 of the illumination sources 1 are inserted. It is also possible to see the arrangement of the rotary controls 13 in the upper housing part 8, and also the switch 11.

FIG. 1e) shows a view according to B-B in FIG. 1c), that is to say a view of the lower housing part 10 from above. Here, it is possible to see how the polarization filter 2 is fixed on the lower part 10 such that it can rotate. For this purpose, the polarization filter 2 is enclosed in a mounting ring 30. The mounting ring 30 has on its outer edge an incision, in which a drive belt 31 runs. This rubber drive belt 31 is tensioned around the mounting ring 30 with the aid of a drive wheel 33. The drive wheel 33 is driven by a motor which is fixed to the lower housing part 10 and projects into the upper housing part 8, by which means the polarization filter 2 can be rotated. For this purpose, the polarization filter 2 is mounted via three freely rotatable guide rollers 34, which likewise engage from the outside in V-shaped flanks of the mounting ring 30 specifically provided for the purpose. This guidance of the polarization filter 2 from the outside makes it possible to carry out the observation centrally through the center of the filter.

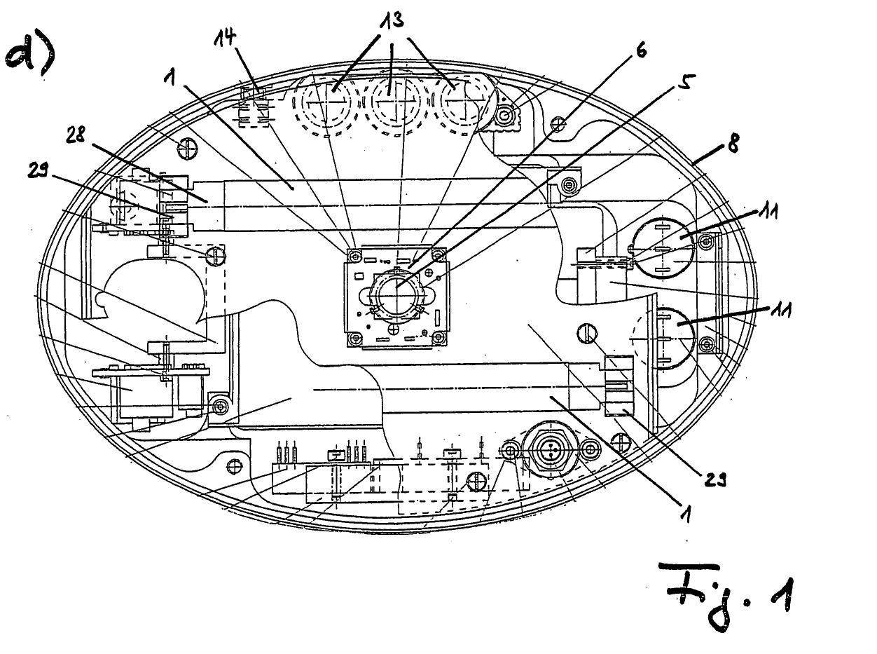

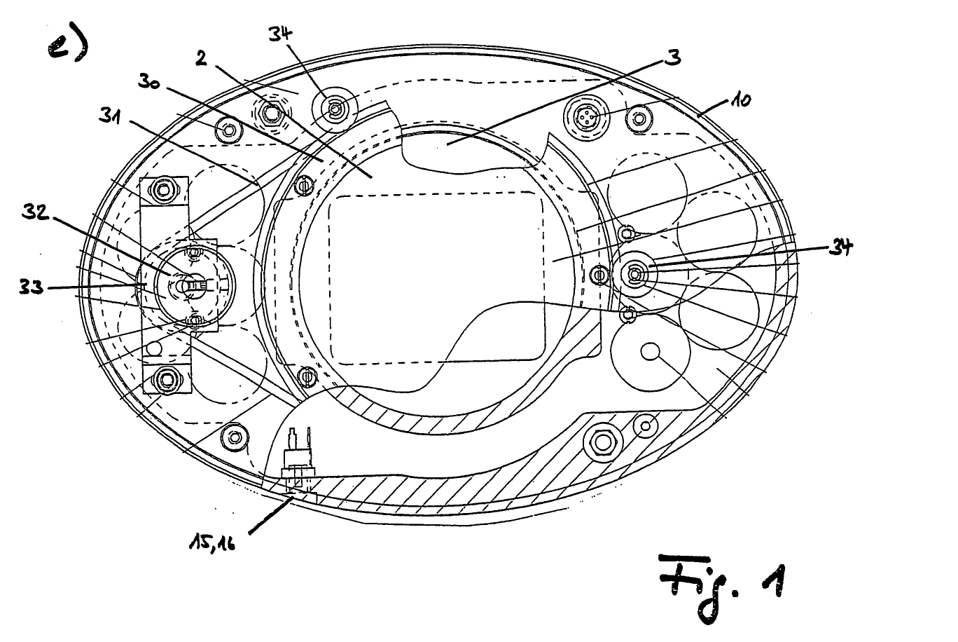

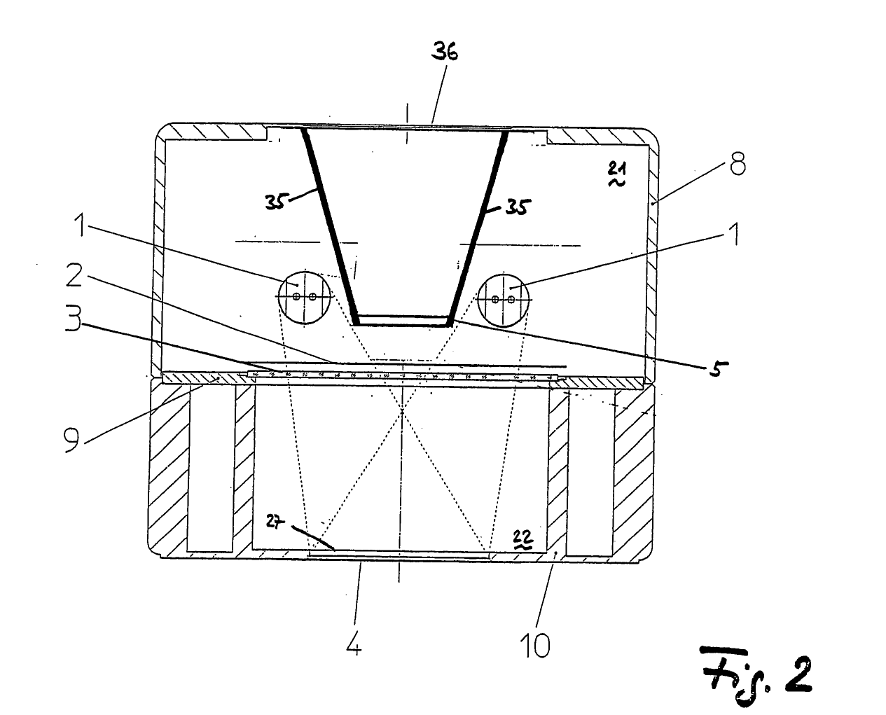

FIG. 2 shows a further exemplary embodiment of the present invention, in which the observation is not implemented electronically. The section illustrated in FIG. 2 substantially corresponds to the section according to FIG. 1b), but there being no display 7 here but instead, at the top, there simply being arranged a window 36 which prevents contamination of the interior 21 of the upper housing part 8. It is likewise possible to replace the window 36 by a magnifying glass, in order to make security features on the object 4 more accurately detectable. In addition, specific aperture stops 35 are provided here, which prevent light being able to fall directly from the light sources 1 onto the observation window 36. The aperture stop 35 can be a flat metal sheet running parallel to the axis of the light sources 1 but, for example in the case of a round window 36, it is also possible to form the aperture stop in the form of a conical truncated cone. Here, too, on the end of the aperture stop 35 facing the object 4 and the polarization filter 2, a filter 5 is provided which filters out light components from the spectral range of the light sources 1 (UV filter). If a sufficiently efficient UV filter 5 is used, it is also possible to dispense completely with aperture stops 35 and to place a filter 5 immediately in front of the window 36 or to replace the window 36 directly by a filter 5.

In order to analyze an object, the object having appropriate security features is now simply placed on a flat surface and an instrument according to one of FIGS. 1 or 2 is guided over the object in such a way that the object is covered by the hole 27. In the process, care should be taken that no light can get into the interior 22 laterally between the object and underside of the housing and in this way diminish the quality of the observation.

### LIST OF DESIGNATIONS

1 UV lamps
2 Rotatable polarization filter
3 Cover glass
4 Object having security feature
5 Filter
6 CCD color camera
7 TFT-LCD color display
8 Upper housing part
9 Sheet metal cover
10 Lower housing part
11 Switch
12 Ventilation slots
13 Rotary control
14 Connector for external display
15 Connection for external supply
16 Connection for battery charger
17 Underside
18 Upper side
19 Grip notches
20 Hand-held instrument with display
21 Hollow space in upper housing part
22 Dark chamber in lower housing part
23 Linearly polarized UV light shone in
24 Unpolarized UV light shone in
25 Visible light output, possibly polarized
26 Fixing screw
27 Hole in underside of 10
28 Top part of 1
29 Mount of 1
30 Mounting ring of 2
31 Drive belt
32 Motor
33 Drive wheel of 32
34 Guide roller for 2
35 Aperture stops
36 Window/lens

1. A device (20) for revealing security elements that are present in an object (4) and that have at least one photoluminescent segment which is characterized by linearly polarized photoluminescence and/or linearly polarized absorption, characterized in that at least one light source (1) and at least one polarization filter (2) are arranged in such a way that the light (24) from the light source (1) is linearly polarized (23) by the polarization filter (2), strikes the object (4) and, respectively, the photoluminescent segments present therein, and photoluminescent light (25) from the segment can be observed through a further and/or the same polarization filter (2).

2. The device (20) as claimed in claim 1, characterized in that the at least one light source (1) emits light in the UV range, and in that the photoluminescent light (25) from the at least one segment lies in the visible range.

3. The device (20) as claimed in claim 1, characterized in that the light source is a UV light source (1) with an emission in the range from 180 to 500 nanometers, preferably in the range from 200 to 400 nanometers, it also being possible for it to be a broadband light source in front of which an appropriate bandpass filter is arranged, so that only UV light in particular in the aforementioned range strikes the object (4).

4. The device (20) as claimed in claim 3, characterized in that the bandpass filter is simultaneously also a polarization filter.

5. The device (20) as claimed in claim 3, characterized in that the light source is a mercury vapor lamp, a laser light source or a halogen lamp or an arc discharge lamp.

6. The device (20) as claimed in claim 1, characterized in that the observation takes place through a filter (5) which substantially does not permit light in the wavelength range of the light source (1) to pass, while light in the wavelength range of the visible photoluminescent light (25) from the segment can pass substantially unimpeded.

7. The device (20) as claimed in claim 1, characterized in that the light (24) shone in and the photoluminescent light (25) from the segment pass through the same polarization filter (2) and the polarization filter (2) for observation can be rotated about an axis perpendicular to the plane of the polarization filter (2), in particular with the aid of a motor (32).

8. The device (20) as claimed in claim 7, characterized in that the polarization filter (2) can be rotated with a rotation frequency in the range from 0.2 to 5 Hz, in particular preferably with a rotation frequency of 0.5 to 2 Hz.

9. The device (20) as claimed in claim 7, characterized in that the polarization filter (2) is enclosed in a mounting ring (30) and in that the polarization filter (2) is rotated by a drive belt (31) which runs around the mounting ring (30) and is driven by a drive wheel (33) moved by a motor (32), in particular the mounting ring (30) preferably being rotatably mounted via at least 3 tangentially engaging guide rollers (34).

10. The device (20) as claimed in claim 1, characterized in that a first polarization filter is arranged between light source (1) and object (4), and in that a second polarization filter is arranged between object (4) and observation, and in that either the first or the second polarization filter can be rotated about an axis at right angles to the plane of the polarization filter, in particular with the aid of a motor, while the respective other polarization filter is not rotated.

11. The device (20) as claimed in claim 1, characterized in that at least 2 light sources (1) are provided, in that there is a polarization filter (2) in front of each of the light sources (1), the polarization directions of the light beams falling on the object (4) from the different light sources (1) being different and the different light sources (1) being activated in an alternating manner.

12. The device (20) as claimed in claim 11, characterized in that 2 light sources (1) are provided, and in that the polarization directions of the light beams falling on the object (4) from the 2 light sources (1) are displaced by 90 degrees, it being possible for the 2 light sources (1) to be switched on and off in an alternating way, preferably at a frequency in the range from 0.2 to 5 Hz, in particular preferably at a frequency of 0.5 to 2 Hz.

13. The device (20) as claimed in claim 1, characterized in that a camera, in particular preferably a CCD color camera (6), is provided for the observation, the image recorded by the camera being depicted on a display, in particular preferably a TFT-LCD color display (7), if appropriate following suitable image processing such as contrast adaptation, color adaptation, brightness adaptation, enlargement and/or resolution adaptation.

14. The device (20) as claimed in claim 13, characterized in that the camera is a multichip camera, in particular preferably a three-chip camera

15. The device (20) as claimed in claim 1, characterized in that the observation is carried out through a lens (36), in particular preferably through a magnifying glass.

16. The device (20) as claimed in claim 1, characterized in that the light source (1) is a UV lamp, preferably a UV tube having a wavelength in the range from 200 to 390 nanometers, in particular preferably having a wavelength in the range from 350 to 370 nanometers, and in that the polarization filter (2) is a broadband linear polarizer which, particularly preferably, has a polarizing action in a wavelength range from 300 to 770 nanometers.

17. The device (20) as claimed in claim 1, characterized in that means for checking further security features are additionally provided, it being possible for the further security features to be magnetic, electric, optical, electronic, electro-optical features, for example selected from the group comprising bar codes, magnetic strips, conductivity, luminescence, photoluminescence, up-conversion (anti-Stokes), infrared signatures, electronically readable text (OCR text), including those with infrared text, X-ray fluorescence features.

18. A method for revealing security elements that are present in an object (4) and that have at least one photoluminescent segment which is characterized by linearly polarized photoluminescence and/or linearly polarized absorption, characterized in that light (24) from at least one light source (1) is linearly polarized (23) by at least one polarization filter (2), strikes the object (4) and, respectively, the photoluminescent segments present therein, and photoluminescent light (25) from the segment is observed through a further and/or the same polarization filter (2), use particularly preferably being made of a device as claimed in claim 1.
